(19) United States
(12) Patent Application Publication
(10) Pub. No.: US 2026/0307816 A1
(43) Pub. Date: Oct. 8, 2026

(54) ACOUSTIC ATTENUATION STRUCTURE PROVIDED WITH S-SHAPED CELLS HAVING DRAINED BARRIERS AND METHOD FOR MANUFACTURING SAME

(71) Applicant: SAFRAN NACELLES, GONFREVILLE L'ORCHER (FR)

(72) Inventors: Marc VERSAEVEL, MOISSY CRAMAYEL (FR); Bertrand Léon Marie DESJOYEAUX, MOISSY CRAMAYEL (FR); Pierre-Yves GINI, MOISSY CRAMAYEL (FR)

(21) Appl. No.: 19/483,310

(22) PCT Filed: May 7, 2024
(86) PCT No.: PCT/FR2024/050603

§ 371 Date: Nov. 11, 2025

(30) Foreign Application Priority Data
May 12, 2023 (FR) FR2304707

(51) Int. Cl. B64D 33/04; B64D 29/00

(52) U.S. Cl. CPC B64D 33/06; B64D 29/00

(57) ABSTRACT

An acoustic panel with resonators for a nacelle of an aircraft propulsion unit, the acoustic panel includes adjoining acoustic cells which form a cellular core, each acoustic cell including an enclosure extending along an acoustic propagation axis of the sound waves and, inside the enclosure, at least one partial obstacle that extends from a wall of the enclosure in a direction transverse to the acoustic propagation axis, the at least one obstacle having at least one edge rigidly attached to a wall of the enclosure and a free edge that delimits an off-centre internal passage in order to increase the length of the path travelled by the sound waves through the acoustic cell. The at least one partial obstacle further includes at least one drainage orifice adjacent to an edge rigidly attached to a wall of the enclosure.

### TECHNICAL FIELD

The present invention relates to the general field of acoustic attenuation structures and the method for their manufacture. More particularly, it relates to acoustic attenuation structures used in reduced volumes, in particular to reduce the noise produced by airplane engines such as gas turbines or exhausts thereof.

### PRIOR ART

The challenges facing commercial aviation in terms of lower fuel consumption and ecological impact are leading to a rethink of aircraft engine architectures. Two characteristics in particular are studied for their influence on the performance of the propulsion unit: the bypass ratio (ratio of the airflow passing via the secondary flow to the airflow passing via the primary flow of the engine) and the drag induced by the propulsion unit.

It has been proven, and is agreed by the entire industry, that increasing the dilution ratio improves engine efficiency (lowering fuel consumption and reducing harmful emissions). In practice, this increase in the bypass ratio is achieved by increasing the diameter of the turbomachine fan. However, this increase in the diameter of the secondary flow leads to a corresponding increase in the diameter of the casing and the nacelle. If the architecture of the fan module is not rethought, it is easy to understand the negative impact of the increase in drag caused by the propulsion unit having larger external surfaces in contact with the air. One of the avenues investigated therefore leads to shortening and slimming down the outer casing and nacelle of the engine in order to reduce its mass and drag.

On current engines, acoustic attenuation is achieved in part by acoustic panels disposed in the casing and nacelle. In order to make the outer casing more compact, the acoustic treatments themselves will have to become more compact.

Acoustic panels are mechanical elements similar to cellular boxes that attenuate noise emitted by the engine. The shape of the cells and the thickness of these panels are designed to reduce engine noise as much as possible, particularly during certain operating phases such as take-off and landing. Noise reduction is all the more important in the vicinity of airports and neighbouring conurbations.

In future engine architectures, two new difficulties will arise: the large-diameter fan will rotate less quickly and will therefore generate lower-frequency sound waves, and the structural casing will no longer completely cover the engine and will therefore no longer effectively confine the noise.

Acoustic attenuation structures typically consist of an acoustic surface plate or skin that is permeable to the acoustic waves that it is desired to attenuate, and a reflective solid plate or skin, referred to as a “closure plate”, a cellular body being disposed between these two skins. The cellular body generally consists of a set of partitions, for example in the shape of a honeycomb. It is well known that such structures form Helmholtz resonators that can attenuate acoustic waves in a certain frequency range. Acoustic attenuation structures of this type are described, in particular, in documents U.S. Pat. No. 5,912,442 and GB 2 314 526. However, the previously described acoustic attenuation structures can only absorb a very restricted frequency range.

With such a structure, the frequency f absorbed is of the order of c/4e, where e is the thickness of the cellular body and c is the speed of sound. Or conversely, the thickness of treatment required to process a frequency f is of the order of c/4f.

Thus if the frequency of the noise to be treated decreases, then the thickness of the treatment required increases. Typically, in the absence of grazing flow effects, a 30 mm thick cellular body is suitable for attenuating frequencies close to 2000 Hz, and a 70 mm thick cellular body is suitable for attenuating frequencies close to 880 Hz.

The thickness of the cellular body corresponds to the distance between the permeable acoustic skin and the impermeable acoustic skin. In other words, the acoustic length of the cells is substantially equal to the height of the cellular core.

This attenuation constraint runs counter to the need to reduce the thickness of the structural casing and its surface area in order to reduce the mass and drag.

However, it is desirable to produce acoustic attenuation structures that extensively treat low frequencies, while having satisfactory performance at medium and high frequencies, for example in the case of a slow-moving engine fan that produces low frequencies and harmonics. In addition, the size and mass of the acoustic attenuation structure should preferably be limited, for example when it is mounted on an aircraft.

To broaden the range of absorbed frequencies, it is known to superimpose two cellular bodies, each preferably having a different size honeycomb structure in order to treat different frequencies. Double Degree Of Freedom (or 2DOF) structures are used for acoustic panels having two distinct superimposed cellular bodies, and Single Degree Of Freedom (SDOF) structures for acoustic panels with a single cellular body. However, this solution with two superimposed cellular bodies has limitations for treating low frequencies. More specifically, in order to reduce the lowest frequencies, it is necessary to use very thick cellular bodies. As a result, the acoustic attenuation structure comprising two stacked cellular bodies for treating both low and high frequencies will be relatively bulky.

Various solutions exist for treating low frequencies while limiting the increase in thickness: the use of a cone introduced into the cells, the inclination of a conventional honeycomb or the manufacture of a labyrinth or S-shaped cell.

EP 3 676 825 proposes an acoustic panel structure with a cellular body having cells with an S-shaped structure inside, in order to increase the distance travelled by sound inside the cell. The acoustic panels described in this document comprise cells having at least one partial obstacle in their interior extending from the inner wall of the cell and preventing the wave from propagating directly along the direction in which the cell extends, i.e. the direction of the thickness of the cellular body.

However, acoustic panels generally also have to meet the requirement of not retaining liquids. However, depending on the gravitational orientation of the acoustic panels, the cellular cores of which comprise additional partial partitions in order to form an internal S-shaped structure, excessive amounts of liquid may be retained, which can be detrimental or even unacceptable for the correct operation and reliability of the system.

### Disclosure of the Invention

The main aim of the present invention is therefore to provide an acoustic panel structure with a cellular body having cells with an S-shaped structure inside, and with a configuration that can also meet the need for drainage while retaining the attenuation adaptation to acoustic frequencies.

According to one object of the invention, an acoustic panel with resonators is proposed for a nacelle of an aircraft propulsion unit, the acoustic panel comprising acoustic cells adjoining one another in a plane orthogonal to an acoustic propagation direction of the sound waves in order to form a cellular core, each acoustic cell comprising an enclosure extending along a main axis parallel to the acoustic propagation axis of the sound waves and, inside the enclosure, at least one partial obstacle that extends from a wall of the enclosure in a transverse direction that is orthogonal to the main axis, said at least one partial obstacle comprising at least one edge rigidly attached to a wall of the enclosure and an internal passage that is off-centre with respect to the central axis of the enclosure parallel to or coincident with the main axis of the enclosure, in order to increase the length of the path travelled by the sound waves through the acoustic cell.

According to a general feature of the invention, said at least one partial obstacle further comprises at least one drainage orifice adjacent to an edge rigidly attached to a wall of the enclosure.

Said at least one drainage orifice provided in a partial obstacle thus enables any residual liquid that may accumulate in the cell at the junctions between the enclosure and a partial obstacle to be evacuated.

Adjacent means “which is in the immediate vicinity” as defined in a dictionary. Thus “a drainage orifice adjacent to an edge rigidly attached to a wall of the enclosure” means an orifice located in the direct vicinity of the edge of the partial obstacle, the orifice being able to be adjoined to said edge or being close to the edge of the obstacle but without being adjoined to this obstacle edge, the edge in question being a rigidly attached edge and therefore adjoined to a wall of the enclosure.

In a first embodiment of the acoustic panel according to the invention, said at least one partial obstacle may comprise a cutout that is off-centre with respect to the central axis of the enclosure, the cutout forming the off-centre internal passage.

In a second embodiment of the acoustic panel according to the invention, said at least one partial obstacle may comprise a free edge spaced apart from a wall of the enclosure, the off-centre internal passage being formed between the free edge and the wall of the enclosure facing said free edge.

In this second embodiment, said free edge of the partial obstacle is opposite an edge rigidly attached to the wall of the enclosure.

In a third embodiment of the acoustic panel according to the invention, said at least one partial obstacle comprises a plurality of edges rigidly attached to a wall of the enclosure along the entire length of the corresponding wall, said length extending in a direction orthogonal to the axis of acoustic propagation, and said at least one partial obstacle comprising at least two drainage orifices.

Providing two drainage orifices instead, will improve drainage efficiency in terms of speed of drainage but also by increasing the number of possible sites for draining residual liquid.

In a fourth embodiment of the acoustic panel according to the invention, each of said edges rigidly attached to a wall of the enclosure along the entire length of the corresponding wall comprises at least one drainage orifice.

Providing one drainage orifice per edge rigidly attached to the acoustic cell enclosure improves the chances of draining any residual liquid whatever the orientation of the acoustic cell with respect to gravity.

The at least one partial obstacle may comprise two drainage orifices adjacent to the same edge rigidly attached to a wall of the enclosure.

Preferably, said at least one drainage orifice has a width greater than or equal to 0.1 mm and a length greater than or equal to 0.2 mm, and a cross-section less than 1 mm² and greater than 0.05 mm².

If the drainage orifices are too small, they will not allow water to pass through efficiently. If they are too large, there is a loss of acoustic efficiency.

Preferably, said at least one orifice has a cross-section of less than 0.5 mm².

More preferably, said at least one orifice has a cross-section of less than 0.2 mm².

In a fifth embodiment of the acoustic panel according to the invention, said at least one drainage orifice may have an elongate shape extending to the edge of the partial obstacle with which it is associated, the drainage orifice being laterally open on said wall of the enclosure rigidly attached to said edge with which the drainage orifice is associated.

In a sixth embodiment of the acoustic panel according to the invention, the acoustic panel may further comprise an acoustically porous skin and an acoustically opaque skin, the cellular core being interposed, along the main axis, between the acoustically porous skin and the acoustically opaque skin, and each enclosure of the cellular core comprises at least two drainage notches, each drainage notch being disposed in a separate wall of the enclosure of the cell on a portion in contact with the acoustically opaque skin.

In a seventh embodiment of the acoustic panel according to the invention, at least one acoustic cell comprises a first partial obstacle and a second partial obstacle, the first partial obstacle and the second partial obstacle being offset along the main axis, the passage delimited by the free edge of the first partial obstacle and the passage delimited by the free edge of the second partial obstacle being radially offset in order to form a baffle provided to increase the length of the path travelled by the sound waves through the associated acoustic cell.

In another object, a nacelle for an aircraft propulsion unit is proposed, which comprises at least one acoustic panel as defined above.

In another object, a method is proposed for manufacturing an acoustic panel in accordance with the invention, said at least one partial obstacle being made from at least one ribbon. This method comprises: a step of perforating the ribbon to form at least one drainage orifice; a fastening step in which said at least one ribbon is fastened to at least one first plate, and in which a second plate is fastened to the first plate by respective nodal portions; a forming step in which non-nodal portions of the first and second plates are shaped such that each non-nodal portion of the first plate constitutes, together with a respective non-nodal portion of the second plate, said peripheral wall delimiting a corresponding acoustic cell of the cellular core, and such that a portion of said at least one ribbon forms said at least one partial obstacle in this acoustic cell, said at least one partial obstacle comprising at least one drainage orifice.

Also proposed is a method for manufacturing an acoustic panel in accordance with the invention, said at least one partial obstacle being made from at least one ribbon. This method comprises: a step of perforating the ribbon to form at least one drainage orifice; a fastening step in which said at least one ribbon is fastened at least to one first plate, and in which a second plate is fastened to the first plate by respective nodal portions; a forming step in which non-nodal portions of the first and second plates are shaped such that each non-nodal portion of the first plate constitutes, together with a respective non-nodal portion of the second plate, said peripheral wall delimiting a corresponding acoustic cell of the cellular core, and such that a portion of said at least one ribbon forms said at least one partial obstacle in this acoustic cell, said at least one partial obstacle comprising at least one drainage orifice.

The method may further comprise a step of cutting the ribbon to form at least one cutout defining said at least one offset internal passage, the cutting step being able to be merged with the perforating step.

### BRIEF DESCRIPTION OF THE DRAWINGS

FIG. 1 is a schematic sectional view illustrating a nacelle equipped with a plurality of acoustic panels according to the invention.

FIG. 2 is a schematic cross-sectional view illustrating the cells of one of the acoustic panels of FIG. 1 equipped with two obstacles forming baffles.

FIG. 3 is a schematic cross-sectional view illustrating the cells of one of the acoustic panels in FIG. 1 equipped with three obstacles forming baffles.

FIG. 4 is a schematic perspective view with cutaway illustrating a hexagonal cell of one of the acoustic panels of FIG. 1 equipped with two obstacles forming baffles.

FIG. 5 illustrates a top view of a cellular core of an acoustic panel of FIG. 2 according to a first mode of implementation of the manufacturing method of the invention.

FIG. 6 illustrates a top view of a cellular core of an acoustic panel of FIG. 2 according to a second mode of implementation of the manufacturing method of the invention.

FIG. 7 shows a flowchart of a manufacturing method for one of the acoustic panels of FIG. 2 according to a mode of implementation of the invention.

### DESCRIPTION OF THE EMBODIMENTS

Identical or similar elements are identified by identical reference signs throughout the figures.

In the description, the terms longitudinal, vertical and transverse will be adopted, in a non-limiting manner, with reference to the L, V, T trihedron indicated in the figures.

The expressions “front” and “rear” will also be used, in a non-limiting manner, with reference to the lower and upper portions respectively of FIGS. 2 to 5.

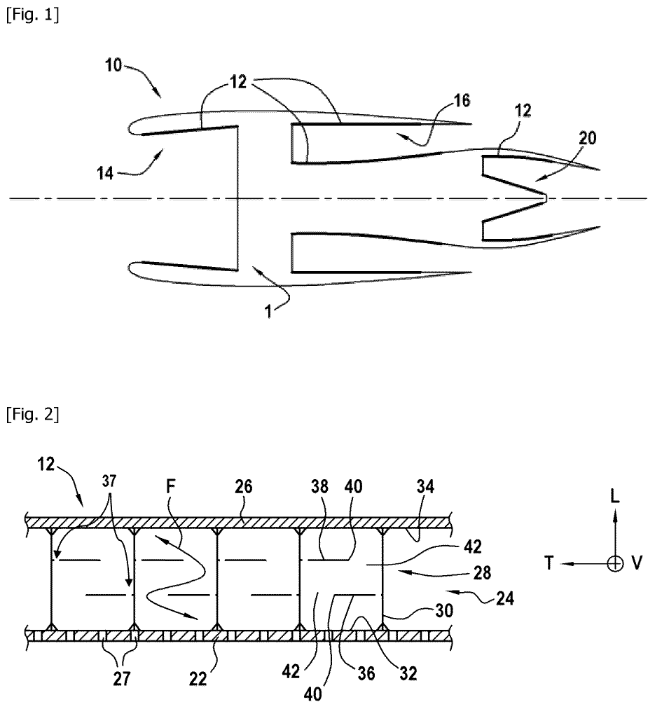

FIG. 1 shows a nacelle 10 equipped with a plurality of acoustic panels 12 with acoustic attenuation resonators, shown schematically in bold lines. Some or all of these, or other acoustic panels, may be totally or partially equipped with cellular cores according to the invention.

The acoustic panels 12 are designed to attenuate the noise emitted by components housed in the nacelle 10, such as an engine or fan (not shown). According to the exemplary embodiments of the invention described here, the acoustic panels 12 are incorporated in an air inlet shroud 14, in the secondary duct 16 and in an ejection nozzle 20.

With reference to FIG. 2, which illustrates a first exemplary embodiment of an acoustic panel 12, the acoustic panel 12 comprises, in succession, from front to rear along the longitudinal axis L, a front acoustic skin 22 which is acoustically porous to sound waves, a cellular core 24, and a solid and therefore acoustically reflective rear skin 26.

The front acoustic skin 22 and the rear skin 26 extend parallel to each other and transversely, i.e. in the transverse direction T which is orthogonal to the longitudinal direction L.

The front acoustic skin 22 has a plurality of perforations 27, or a permeability formed by a mesh, the perforations 27 being suitable for allowing sound waves to penetrate into the cellular core 24.

The cellular core 24 comprises a plurality of acoustic cells 28, or alveoli 28, which are joined together in the transverse direction T and the vertical direction V to form a hollow structure such as a “honeycomb”. The direction of the longitudinal axis L corresponds to the direction of acoustic propagation of a sound wave entering an acoustic cell 28 via the acoustic skin 22.

Each cell 28 is delimited by a peripheral enclosure 30 extending substantially parallel to the longitudinal direction L, from the acoustic skin 22 to the rear skin 26. The shape of the cell 28 can be hexagonal in cross-section, as shown in FIG. 4, or rectangular, square, circular or any other polygonal, curvilinear or mixed geometric shape.

Each cell 28 also extends along a main longitudinal axis L, corresponding overall to an axis of propagation of sound waves, from a front end 32 of the cell 28 resting on the acoustic skin 22, to a rear end 34 resting on the rear skin 26.

Note that the cells 28 are acoustically independent. The term “acoustically independent cells” refers to cells for which the enclosure 30 does not significantly propagate acoustic waves from one cell 28 to another. These terms refer to cells separated by tight walls or walls perforated with one or more small orifices of limited number, the main function of which is to facilitate the evacuation of liquids that may enter the cells. These orifices are preferably two to four in number, with a unit cross-section of the order of 1 to 4 mm², and are located in the enclosure 30 of the cells, in the immediate vicinity of the rear end 34 of the acoustic core against the rear skin 26.

As can be seen in the exemplary embodiment shown in FIG. 2, each cell 28 has at least one first partial obstacle 36 and also, in this example, a second partial obstacle 38 which extend overall in the transverse direction T from the enclosure 30 of the cell 28. In other words, the obstacles 36 and 38 extend in a plane perpendicular to the main axis of the associated cell 28, the main axis of the cell 28 being coincident with the direction of the longitudinal axis L.

Moreover, each obstacle 36, 38 has a free edge 40 which delimits a passage 42 with the opposite wall 30, in order to allow the passage of sound waves penetrating into the associated cell 28.

The obstacles 36, 38 are offset in depth along the main longitudinal axis L of the associated cell 28.

The obstacles 36, 38 are substantially opposite, i.e. the first obstacle 36 extends from a first hooking edge 41a on the left-hand side of the wall 30, as shown in FIGS. 2 and 4, and the second obstacle 38 extends from a second hooking edge 41b on the opposite right-hand side of the wall 30, in order to form a baffle provided to increase the length of the path travelled by the sound waves through the associated cell 28.

Moreover, the length of each obstacle 36, 38 is adapted so that the obstacles 36, 38 partially overlap when viewed in longitudinal projection on a surface perpendicular to the longitudinal direction.

In this way, the sound waves follow a sinuous trajectory between the obstacles 36, 38, from the front end 32 to the rear end 34 of the associated cell 28. This sinuous trajectory is therefore longer than the straight line distance between the two end faces 32 and 34.

As illustrated by arrow F in FIG. 2, the sound waves follow a sinuous path that has an apparent length greater than the length of a straight path.

In addition, each obstacle 36, 38 comprises at least one drainage orifice 37 located close to or even adjoined to the wall of the enclosure 30 to which the obstacle 36, 38 is fastened. Each drainage orifice 37 thus enables any liquid retained by the obstacle 36, 38 to be evacuated.

As illustrated in FIG. 4, each acoustic cell 28 further comprises two drainage notches 31, each provided in a wall of the enclosure 30 at the junction with the rear skin 26.

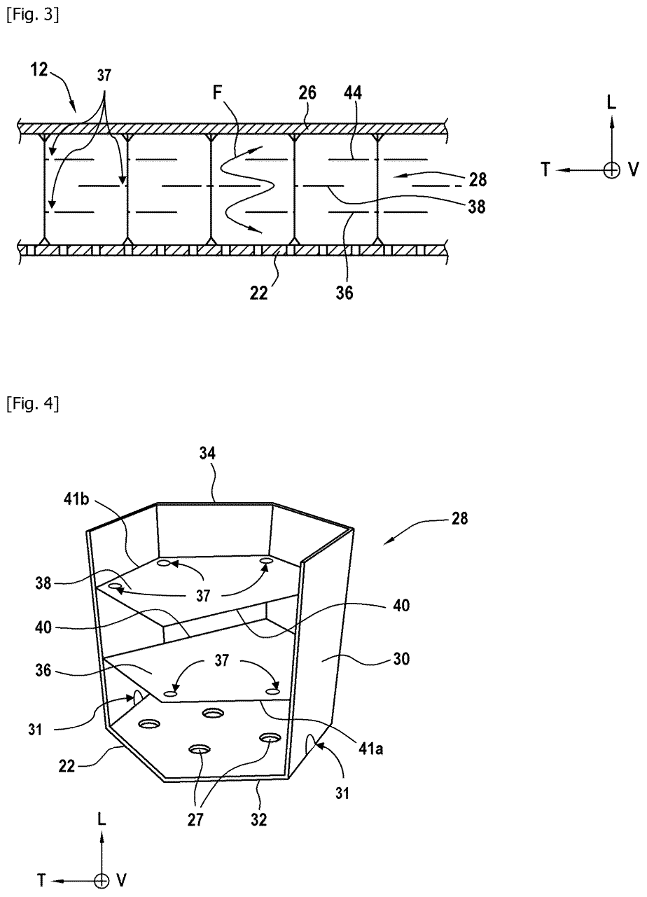

According to another exemplary embodiment shown in FIG. 3, which is similar to the example shown in FIG. 2, each cell 28 comprises a third obstacle 44, the three obstacles 36, 38, 44 have dimensions such that two successive obstacles in the longitudinal direction have a cumulative surface area greater than the cross-section of the cell and a projected surface area covering the entire cross-section. In other words, the obstacles are arranged to impose a sinuous path on the sound waves travelling through the associated cell 28, as shown by the arrow F.

The cells 28 can be made of a thermoplastic composite material and the obstacles can be made of a metal material. The obstacles 36, 38 can also be welded to the material forming the cells 28.

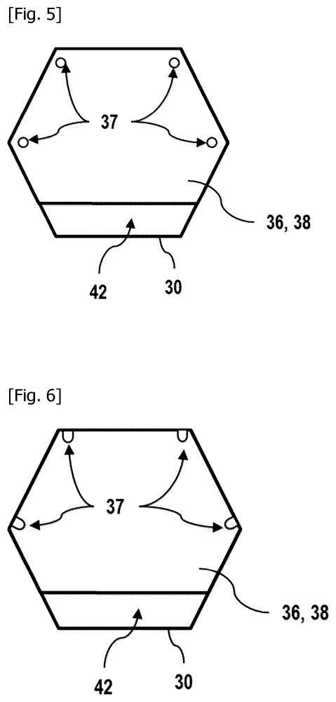

FIG. 5 illustrates a top view of an obstacle 36, 38 according to a particular embodiment. In this embodiment, the obstacle 36, 38 comprises four drainage orifices 37 each placed at a vertex of the hexagon formed by the obstacle 36, 38.

Each vertex of the hexagon comprising a drainage orifice 37 is formed by two edges of the obstacle 36, 38 which are rigidly attached to a wall of the enclosure 30.

FIG. 6 illustrates a top view of an obstacle 36, 38 according to a particular embodiment, different from that of FIG. 5. This embodiment differs from that of FIG. 5 in that the drainage orifices 37 have an elongate shape, rather than circular as in FIG. 5. The shape of the drainage orifices 37 is elongate up to the wall of the enclosure 30, the orifice thus being in direct contact with the wall of the enclosure 30.

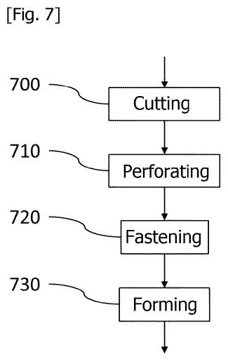

Such an acoustic panel can be manufactured using a manufacturing method as described in document FR 3 070 530, with the addition of a preliminary step of perforating the ribbons in order to provide drainage orifices in the obstacles 36, 38. FIG. 7 schematically shows another method for manufacturing an acoustic panel in accordance with the invention, said at least one partial obstacle being made from at least one ribbon.

The manufacturing method shown in FIG. 7 comprises a step 700 of cutting the ribbon, a step 710 of perforating the ribbon to form at least one drainage orifice, a fastening step 720 and a forming step 730.

During the ribbon cutting step 700, the ribbon is cut to form at least one cut defining at least one offset internal passage.

During step 720 of perforating the ribbon, the ribbon is fastened to at least one first plate and a second plate is fastened to the first plate by respective nodal portions.

In the forming step 730, non-nodal portions of the first and second plates are shaped such that:
each non-nodal portion of the first plate forms, with a respective non-nodal portion of the second plate, the peripheral wall delimiting a corresponding acoustic cell of the cellular core, and such that
a part of the ribbon forms the partial obstacle in this acoustic cell, the partial obstacle comprising at least one drainage orifice.

The cutting step 700 can be merged with the perforation step 710.

The acoustic panel according to the invention thus provides an acoustic panel structure with a cellular body having cells with an S-shaped structure on the inside and with a configuration that can also meet the need for drainage while retaining the attenuation adaptation to acoustic frequencies.

1. An acoustic panel with resonators for a nacelle of an aircraft propulsion unit, the acoustic panel comprising acoustic cells adjoining one another in a plane orthogonal to an acoustic propagation direction of the sound waves in order to form a cellular core, each acoustic cell comprising an enclosure extending along a main axis parallel to the acoustic propagation axis of the sound waves and, inside the enclosure, at least one partial obstacle that extends from a wall of the enclosure in a transverse direction that is orthogonal to the main axis, said at least one partial obstacle comprising at least one edge rigidly attached to a wall of the enclosure and an internal passage that is off-centre with respect to the central axis of the enclosure parallel to or coincident with the main axis of the enclosure in order to increase the length of the path travelled by the sound waves through the acoustic cell, said at least one partial obstacle further comprising at least one drainage orifice,
wherein said at least one drainage orifice is adjacent to an edge rigidly attached to a wall of the enclosure and has an elongate shape extending to the edge of the partial obstacle with which it is associated, the drainage orifice being laterally open on said wall of the enclosure rigidly attached to said edge with which the drainage orifice is associated.

2. The acoustic panel according to claim 1, wherein said at least one partial obstacle comprises a cutout off-centre with respect to the central axis of the enclosure, the cutout forming the off-centre internal passage.

3. The acoustic panel according to claim 1, wherein said at least one partial obstacle comprises a free edge spaced apart from a wall of the enclosure, the off-centre internal passage being formed between the free edge and the wall of the enclosure facing said free edge.

4. The acoustic panel according to claim 3, wherein said free edge of the partial obstacle is opposite an edge rigidly attached to the enclosure wall.

5. The acoustic panel according to claim 1, wherein said at least one partial obstacle comprises a plurality of edges rigidly attached to a wall of the enclosure along the entire length of the corresponding wall, said length extending in a direction orthogonal to the axis of acoustic propagation, and said at least one partial obstacle comprising at least two drainage orifices.

6. The acoustic panel according to claim 5, wherein each of said edges rigidly attached to a wall of the enclosure along the entire length of the corresponding wall comprises at least one drainage orifice.

7. The acoustic panel according to claim 1, wherein said at least one partial obstacle comprises two drainage orifices adjacent to a same edge rigidly attached to a wall of the enclosure.

8. The acoustic panel according to claim 1, wherein said at least one drainage orifice has a width greater than or equal to 0.1 mm and a length greater than or equal to 0.2 mm, and a cross-section of between 0.05 mm² and 1 mm^{2.}

9. The acoustic panel according to claim 1, wherein said at least one drainage orifice has a cross-section of less than 0.5 mm².

10. The acoustic panel according to claim 1, wherein said at least one drainage orifice has a cross-section of less than 0.2 mm².

11. (canceled)

12. The acoustic panel according to claim 1, further comprising an acoustically porous skin and an acoustically opaque skin, the cellular core being interposed, along the main axis, between the acoustically porous skin and the acoustically opaque skin, and each enclosure of the cellular core comprises at least two drainage notches, each drainage notch being disposed in a separate wall of the enclosure of the cell on a portion in contact with the acoustically opaque skin.

13. The acoustic panel according to claim 1, wherein at least one acoustic cell comprises a first partial obstacle and a second partial obstacle, the first partial obstacle and the second partial obstacle being offset along the main axis, the passage delimited by the free edge of the first partial obstacle and the passage delimited by the free edge of the second partial obstacle being radially offset in order to form a baffle provided to increase the length of the path travelled by the sound waves through the associated acoustic cell.

14. A nacelle for an aircraft propulsion unit, comprising at least one acoustic panel according to claim 1.

15. A method of manufacturing an acoustic panel according to claim 1, wherein said at least one partial obstacle is made from at least one ribbon, the method comprising:
perforating the ribbon to form at least one drainage orifice,
fastening the at least one ribbon to at least one first plate, and fastening a second plate to the first plate by respective nodal portions,
a forming step in which non-nodal portions of the first and second plates are shaped such that each non-nodal portion of the first plate constitutes, together with a respective non-nodal portion of the second plate, said peripheral wall delimiting a corresponding acoustic cell of the cellular core, and such that a portion of said at least one ribbon forms said at least one partial obstacle in this acoustic cell, said at least one partial obstacle comprising at least one drainage orifice.
